(19) United States
(12) Patent Application Publication
(10) Pub. No.: US 2025/0286401 A1
(43) Pub. Date: Sep. 11, 2025

(54) SOLAR CHARGER FOR A HEAD-MOUNTED WEARABLE DEVICE

(71) Applicant: GOOGLE LLC, Mountain View, CA (US)

(72) Inventors: Lijun Li, San Diego, CA (US); Kai Xu, Mississauga (CA)

(21) Appl. No.: 18/600,502

(22) Filed: Mar. 8, 2024

(51) Int. Cl. H02J 7/35; G02B 27/01; G02C 7/10; H02J 7/00; H02S 40/38

(52) U.S. Cl. CPC H02J 7/35; G02B 27/0172; G02C 7/102; H02J 7/0048; H02S 40/38; G02B 2027/0118; G02B 2027/0178; H02J 2207/50

(57) ABSTRACT

A head-mounted wearable device (HMWD), such as a set of augmented reality (AR) and/or virtual reality (VR) smart glasses may include a solar charging system. The solar charging system has one or more solar panels that may be implemented within the left and right temple regions of the set of AR glasses. Additionally, a supplementary solar panel may be integrated into a variable dimmer apparatus, enabling power generation in outdoor environments with ample sunlight, while concurrently modulating the incoming light to enhance user eye comfort. The solar charging system may include a super capacitor to facilitate operation under low-light conditions. This entails the collection of light energy during weak illumination and accumulating power in the capacitor before subsequent discharge to charge the battery. Moreover, the solar charging system is equipped with one or more light intensity sensors, allowing for real-time detection and responsive adjustments.

### BACKGROUND

A technical challenge in designing a head-mounted wearable device (HMWD), such as a set of smart glasses, augmented reality (AR), and/or virtual reality (VR) glasses, is the optimization of battery life. User comfort may be achieved with a lightweight design which may impose constraints on the permissible battery size, typically capped at 200 milliampere-hour. Advancements in the reduction of the weight of the HMWD contribute to a prevailing trend of downsizing the battery. Complicating matters is the user requirement to wear the glasses throughout an entire day, engaging in various always-on activities such as message notifications, photo and video capture, and/or navigation. This necessitates a battery capacity that may sustain prolonged usage without the need for recharging during the day, with the expectation that users will charge the glasses overnight. The dual objectives of minimizing weight and maximizing battery life pose a fundamental contradiction.

Some low-power challenges associated with AR/VR smart glasses stem from the inherent contradictions in their design requirements. The lightweight construction is configured for user comfort during extended wear and may inevitably translate to a limitation in battery capacity. This limitation is further compounded by the necessity for high-resolution displays and a high frame rate to enable responsive rendering aligned with head and eye movements configured to minimize motion sickness by maintaining motion-to-photon latency below, for example, 10 milliseconds. Additionally, the adoption of a split compute architecture that necessitates high bandwidth and low-latency connectivity between the smart glasses and a paired mobile device, introduces its own set of power consumption challenges. Furthermore, the expectation for whole-day wear, with the glasses being charged overnight by a user, poses a conflicting demand for sustained operational capabilities without frequent recharging. Balancing these conflicting requirements presents a challenge and facilitates a compromise between performance and power efficiency.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a schematic diagram of an equivalent circuit of a solar charging system implemented in an HMWD in accordance with some embodiments.

FIG. 2 is a diagram illustrating an example HWMD implementing the solar charging system of FIG. 1 and a close-up view of a variable dimmer employed by the solar charging system in accordance with some embodiments.

FIG. 3 is a flowchart illustrating a solar charging process for light intensity detection implemented by the solar charging system of the HMWD of FIGS. 1 and 2 in accordance with some embodiments.

### DETAILED DESCRIPTION

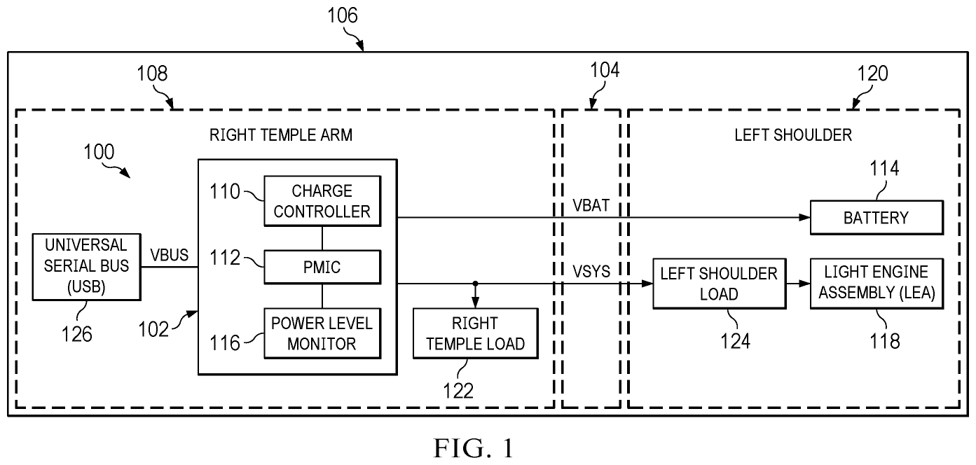

FIGS. 1-3 illustrate example systems and processes for employing a solar charging system with one or more solar panels in a HMWD, such as a set of smart glasses, AR and/or VR glasses. The solar charging system has one or more solar panels that may be implemented within the left and/or right temple regions of the HMWD. Additionally, a supplementary solar panel may be integrated into a variable dimmer apparatus, enabling power generation in outdoor environments with ample sunlight, while concurrently modulating the incoming light to enhance user eye comfort. The solar charging system may include a super capacitor to facilitate operation under low-light conditions. This entails the collection of light energy during weak illumination and accumulating power in the capacitor before subsequent discharge to charge the battery. Moreover, the solar charging system is equipped with one or more light intensity sensors, allowing for real-time detection and responsive adjustments. For example, in a low light setting, such as during nighttime and/or in environments with minimal indoor lighting, the solar charging system functionality may automatically deactivate to conserve energy resources.

The incorporation of the solar charging system in the HMWD may offer various benefits. Firstly, a solar charging system utilizes a near-limitless energy source, harnessing power from both natural sunlight and indoor artificial light. This characteristic not only ensures a continuous and sustainable power supply but also aligns with environmentally conscious practices by utilizing renewable energy. A solar charging system employed in the HMWD may facilitate an optimized user experience in indoor and/or outdoor environments, as the system leverages the available sunlight and/or artificial light to enhance performance, thus making the HMWD well-suited for outdoor use where traditional power sources may be limited. The solar charging system may also exhibit high efficiency, especially in optimal conditions. For example, when the solar charging system of the HMWD is exposed to sunlight with a lux level exceeding 15,000, the solar charging efficiency of the solar charging system may reach approximately 80%. As a result of an approximately 80% efficiency, for example, effective energy may be harvested and may contribute to the overall power needs of the HMWD. By harnessing solar energy, the HMWD may extend the battery life, allowing users to comfortably wear the HMWD throughout the day without the need for frequent recharging. Beyond the functional benefits, solar charging aligns with eco-friendly principles, promoting a green and carbon-free energy solution. This not only reduces the environmental impact associated with traditional power sources but also contributes to a more sustainable and Earth-friendly technology ecosystem. Moreover, the integration of the solar charging system of FIG. 1 in the HMWD may address some challenges including, but not limited to, the challenges of achieving whole-day wear without increasing the physical battery capacity, for example.

FIG. 1 illustrates an example of an equivalent circuit of a solar charging system 100 for use in an HWMD 106 in accordance with some embodiments. The solar charging system 100 has one or more solar panels such as a first solar panel 102 connected to a charge controller 110. The first solar panel 102 of the one or more solar panels may be disposed at a first side of a frame 104 of the HMWD 106. In an example, the first side of the frame 104 of the HMWD 106 is a first temple arm, such as a right temple arm 108 and/or a left temple arm (not shown). The charge controller 110 is configured to optimize the power output from the first solar panel 102 by adjusting the electrical operating point. The output from the charge controller 110 may be directed to the power management integrated circuit (PMIC) 112. The PMIC 112, in turn, manages the power flow within the system to facilitate the charging of an energy storage device, such as a battery 114 and/or a supercapacitor (not shown). A protection circuit module (PCM) may be employed by the solar charging system 100 to safeguard the battery 114 and/or other elements within the circuit. The PCM typically functions to monitor the voltage, current, and/or temperature of the battery 114 to prevent overcharging and/or discharging and to ensure the battery 114 operates within safe limits. The battery 114 may be disposed at a portion of a second side of the frame 104 of the HMWD 106. The second side of the frame 104 may include a second temple arm such as the left temple arm. The right temple arm 108 may have the first solar panel 102 electrically connected to universal serial bus (USB) 126 interface such as a dongle USB configured to connect to a computer and/or an electronic device through a USB port.

In implementations, a system buck converter (not shown) may be included in the solar charging system 100 for the HMWD 106. Typically, a system buck converter is a type of DC-DC converter designed to regulate and optimize the variable voltage generated by the solar panel. The buck converter may comprise components such as, an inductor, a switch, a diode, and/or a capacitor configured to step down the incoming voltage to a stable level suitable for charging the energy storage. The buck converter involves periodic switching of a transistor to store and transfer energy to ensure that the charging process remains efficient, adaptable to changing solar conditions, and maintains a consistent voltage for safe and optimal charging of the energy storage device.

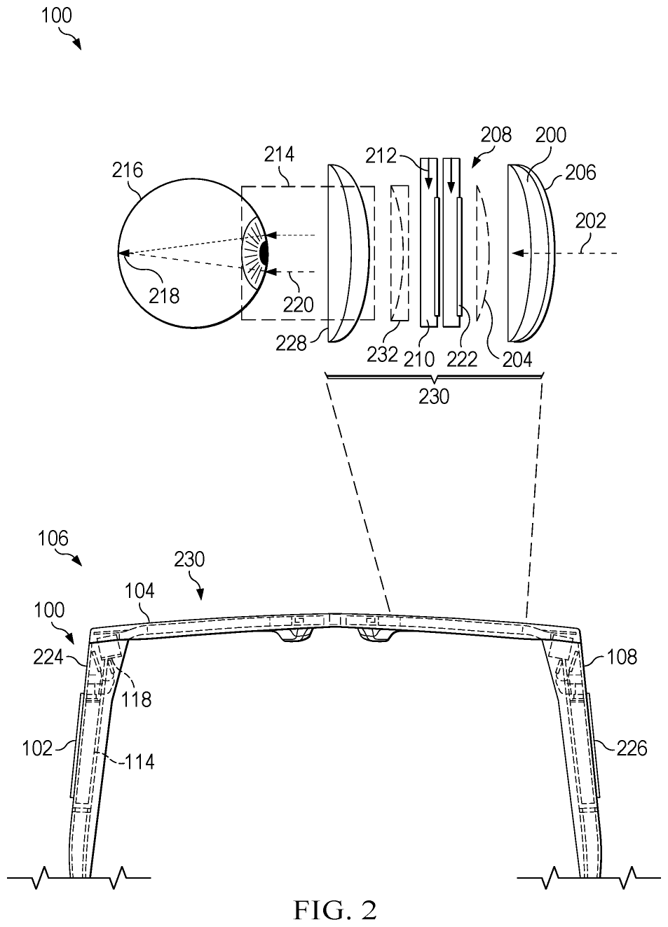

As noted, in at least one embodiment a power level monitor 116 is configured to monitor the state of charge and/or other battery parameters and may be integrated into and/or connected to the energy storage device. The PMIC 112 further connects to one or more loads, such as a right temple load 122 and/or a left shoulder load 124, to ensure a stable power supply to the HMWD 106 being powered, while communication lines may exist between the PMIC 112 and the power level monitor 116 for real-time monitoring of the battery's status and health. Further, these connections may create a cohesive system for efficient solar energy harvesting, storage, and/or power distribution. The one or more loads in the solar charging system 100 is any component that relies on the stored energy for operation. For example, the one or more loads may include, but not be limited to a light engine assembly (LEA) 118 disposed at one or more shoulders, such as a right shoulder (not shown) and/or a left shoulder 120 of the frame 104 of the HMWD 106. The PMIC is configured to serve as the intermediary, connecting to load of the one or more loads to facilitate the regulated distribution of power. This connection ensures that the load, which may include a solar charger and/or components, one or more sensors and/or components in an optical projection system, such as a LEA, a dimmer and/or variable dimmer, as described in FIG. 2, utilized in the HMWD 106, receives a stable and controlled power supply from the battery 114 and/or supercapacitor.

FIG. 2 illustrates the solar charging system 100 implemented in the HMWD 106 of FIG. 1 including a variable dimmer 200 in accordance with embodiments. The variable dimmer 200 may be located facing a world side and configured to receive light 202 from the world side. The variable dimmer 200 may include a photochromic lens 206 disposed at a world side of a portion of a micro-light emitting diode (microLED) display 208. The portion of the microLED display 208 may include any portion of an optical projection system, such as at an output coupler (OC) 222 and/or any diffractive element and/or any surface of one or more waveguides 210 optically coupled to the LEA 118. The microLED display 208 is configured to transmit collimated light to the one or more waveguides 210, where light 212 propagates through the one or more waveguides 210.

The solar charging system 100 described herein utilizes the variable dimmer 200 disposed at a world facing side of a solar panel 204 and is configured to decrease the intensity of light input into an optical system such as a see-through stack (STS) 230. For example, the solar panel 204 is disposed between the photochromic lens 206 and the one or more waveguides 210 of the microLED display 208. The photochromic lens 206 may be optically aligned with an eyebox 214. The eyebox 214 in the HMWD 106 typically includes the space, either physical or virtual, where a user (not shown) may position their eye 216 to perceive augmented content 218. The eyebox 214 represents the area within which digital overlays 220 are visible and accommodate the user's head movements to ensure an optimal viewing experience. The size and design of the eyebox 214 influences the freedom of eye and head movements and may contribute to the overall usability and immersion in augmented reality. A projection lens 232 may be disposed at a world side of a prescription lens 228. The STS 230 may comprise the projection lens 232 disposed between the prescription lens 228 and the one or more waveguides 210 and the solar panel 204 disposed between the photochromic lens 206 and the one or more waveguides 210.

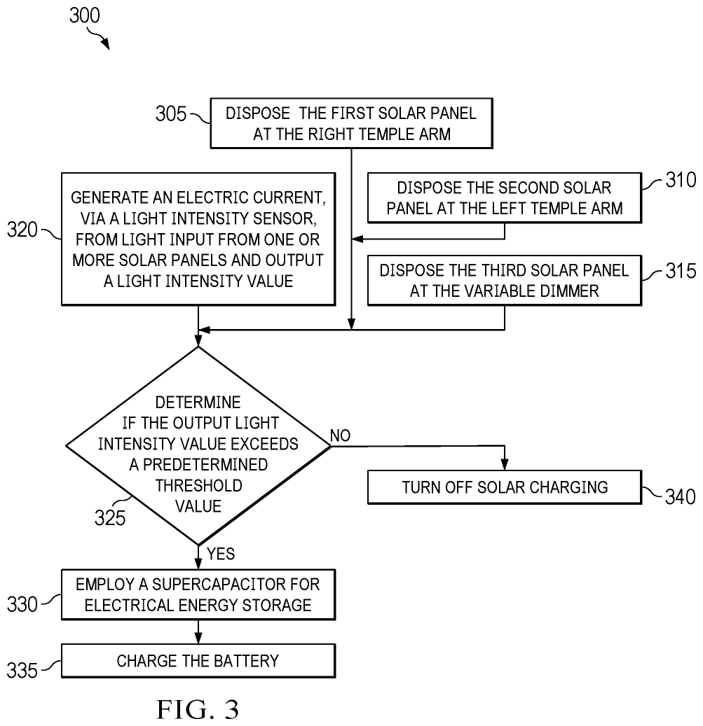

Further, in implementations the HMWD may comprise the first solar panel 102 disposed at the first side of a frame 104 of the HMWD 106. In an example, the first side of the frame 104 of the HMWD 106 is a first temple arm, such as a right temple arm 108. A second solar panel 226 of the one or more solar panels may be disposed at a second side of the frame 104 of the HMWD. In an example, the second side of the frame 104 of the HMWD 106 is a second temple arm, such as a left temple arm 224. The solar charging system 100 may be configured to include a plurality of solar panels electrically connected to one or more sensors. The one or more sensors may be configured for real-time light intensity detection for automatic and/or manual activation and/or deactivation of the solar panels as shown in FIG. 3.

FIG. 3 illustrates an example solar charging process 300 implemented by a light intensity sensor in the solar charging system 100 of the HMWD 106 of FIGS. 1 and 2 in accordance with some embodiments. At block 305, the first solar panel 102 is disposed at the right temple arm of the HMWD 106. At block 310, the second solar panel 226 is disposed at the left temple arm of the HMWD 106. At block 315, a variable dimmer 200 is provided and the third solar panel 204 is disposed at the variable dimmer 200 of the HMWD 106. The solar panel 204 of the variable dimmer 200 may be referred to as the third solar panel 204. At block 320, one or more of the first solar panel 102, the second solar panel 226, and/or the third solar panel 204 and may be electrically connected to one or more light intensity sensors. A light intensity sensor may be configured to generate an electric current from the light input from the one or more of the first solar panel 102, the second solar panel 226, and/or the third solar panel 204. At block 325, the output light intensity value from the light intensity sensor is compared to a predetermined threshold value. To adjust the behavior of the solar panels or to control the variable dimmer in response to changing environmental conditions, a parallel processor (not shown) determines if the output light intensity value exceeds a predetermined threshold value. A parallel processor is employed to perform this comparison and evaluates whether the output light intensity value surpasses the predetermined threshold value.

At block 330, a supercapacitor may be employed to store excess electrical energy generated by the solar panels when the light intensity surpasses a predetermined threshold. This serves as a mechanism to efficiently capture and retain the surplus energy during optimal light conditions. Utilizing a supercapacitor for electrical storage facilitates the charging of the battery in the HMWD by serving as an intermediary energy buffer. For example, during periods of optimal light intensity, the solar panels generate electrical energy, and the surplus is directed to charge the supercapacitor. The supercapacitor captures and holds the excess energy. When the HMWD requires power and the solar input is insufficient, a controlled energy transfer process is initiated, allowing the stored energy in the supercapacitor to gradually charge the battery. At block 335, the battery of the HMWD is charged. The solar charging process 300 ensures an optimized charging rate, regulates voltage levels, and may prevent overcharging, which may contribute to a consistent and reliable power supply for the head-mounted wearable device. Integrating the supercapacitor in this manner may enhance overall energy management, enabling the HMWD to operate efficiently during variable environmental conditions.

At block 340, the solar panels may be effectively turned off to conserve energy when the light intensity does not exceed a predetermined threshold. This process may involve implementing a mechanism configured to disconnect the solar panels from the electrical system or load when the ambient light conditions are below the specified threshold. By turning off the solar panels in such cases, unnecessary energy harvesting is avoided and may prevent the system from expending power resources when it is not needed. This approach is aimed to optimize energy efficiency and ensure that the solar panels operate only when there is a sufficient level of light intensity to justify their activation.

Typically, the supercapacitor is known for its rapid charging and discharging capabilities and allows for quick storage of the excess energy. This stored energy may then be accessed during periods of lower light intensity, contributing to a more stable and efficient energy utilization strategy within the solar charging system. If the measured light intensity exceeds the threshold, it indicates that the ambient light conditions are favorable or have reached a certain desired level. In response to this determination, the system can then initiate appropriate actions, such as optimizing the orientation or output of the solar panels to enhance energy harvesting and/or adjusting the variable dimmer to regulate the intensity of light in an optical system.

In an embodiment, the light intensity sensor may output a light intensity value typically measured in units such as lux or illuminance. Lux is the standard unit for measuring illuminance, which represents the amount of luminous flux (light) falling on a surface per unit area. The output value will depend on the specific light intensity sensor and its calibration. For example, in a well-lit indoor environment, the light intensity might be in the range of a few hundred lux, while direct sunlight outdoors can provide tens of thousands of lux. The light intensity sensor's output may reflect the brightness of the ambient light, and this data can be used to adjust the behavior of the solar panels or to control the variable dimmer in response to changing environmental conditions.

Further, in implementations, a typical light intensity sensor may include photodiodes and/or photovoltaic cells. Photodiodes are semiconductor devices that generate an electrical current when exposed to light. Light intensity sensors may be integrated into or placed in close proximity to one or more solar panels of the plurality of solar panels. As sunlight and/or ambient light falls on the one or more solar panels, the photodiodes may detect the intensity of light and convert it into an electrical signal. This signal is then used to monitor the light conditions and adjust the operation of the solar panels to ensure optimal energy harvesting based on the available light intensity.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A head-mounted wearable device (HMWD) comprising:
a solar charging system comprising:
one or more solar panels including a first solar panel disposed at a first side of a frame of the HMWD;
a controller electrically connected to the one or more solar panels;
an energy storage device disposed at a second side of the frame of the HMWD and electrically connected to a power level monitor; and
a power management integrated circuit (PMIC) electrically connected to the energy storage device and is electrically connected to one or more loads of the HMWD.

2. The HMWD of claim 1, further comprising:
a light intensity sensor electrically connected to the one or more solar panels and to a processor.

3. The HMWD of claim 1, wherein the energy storage device is a supercapacitor.

4. The HMWD of claim 1, wherein the first side of the frame of the HMWD is a first temple arm.

5. The HMWD of claim 4, wherein the second side of the HMWD is a second temple arm.

6. The HMWD of claim 1, wherein the one or more loads includes a light engine assembly disposed at one or more shoulders of the frame of the HMWD.

7. The HMWD of claim 1, wherein the one or more loads includes a dimmer.

8. The HMWD of claim 1, further comprising:
a second solar panel of the one or more solar panels disposed at the second side of the frame of the HMWD.

9. The HMWD of claim 1, further comprising:
a dimmer comprising:
a photochromic lens disposed at a world side of a micro-light emitting diode (microLED) display; and
a solar panel disposed between the photochromic lens and the microLED display.

10. The HMWD of claim 9, wherein the photochromic lens is optically aligned with an eyebox.
